(19) United States
(12) Patent Application Publication
(10) Pub. No.: US 2005/0165785 A1
(43) Pub. Date: Jul. 28, 2005

(54) SOCIAL NETWORK SURFING

(75) Inventors: Peter K. Malkin, Ardsley, NY (US); Thomas D. Erickson, Minneapolis, MN (US); Wendy A. Kellogg, Yorktown Heights, NY (US)

Correspondence Address: IBM CORPORATION, T.J. WATSON RESEARCH CENTER, P.O. BOX 218, YORKTOWN HEIGHTS, NY, 10598, US

(73) Assignee: IBM CORPORATION, Yorktown Heights, NY (US)

(21) Appl. No.: 10/707,917

(22) Filed: Jan. 23, 2004

(51) Int. Cl. G06F 17/30

(52) U.S. Cl. 707/10

(57) ABSTRACT

Disclosed is a method for allowing the sharing of social relationships collections including the step of creating a social relationship collection object for a first user that provides access to at least one individual with whom they have a social relationship and allowing a second user to retrieve the social relationship collection object. As a result of allowing said second user to retrieve the social relationship collection object, the second user inspects a reference contained in the first user's social relationship collection object.

### BACKGROUND OF INVENTION

Knowledge of a person's personal social relationships is extremely useful for many reasons. If one knows that they and a stranger have a common friend or colleague, they can approach this new person with significant common ground and a strong reference. One can also use the knowledge of another's social relationships to find particular sorts of expertise. For example, if a first user was looking for help with particular type of technical patent, they could look up similar sorts of patents, determine the inventors and then see if any of the inventors were either close to them, or close to someone to whom they were close.

How can one learn up to date information about a given user's personal relationships using online resources? Buddy lists, like those provided by Lotus Sametime allow a given user to author lists of those to whom they are close, even enabling a given user to categorize these contacts. No teachings are provided allowing others to see this data.

Searches for references to a given user, either as the author of papers or as the inventor of particular patents, enable one both to determine the given user's fields of expertise, and to learn others with whom the given user has collaborated an important form of relationship. Since the lists of collaborators generated in this way are formed automatically, rather than being created and updated by the given user, one cannot know whether or not the given user is or was really close to anyone listed; all one can say is they both appeared as authors on one or more documents. A buddy list does not guarantee this either, but is likely a better guideline to highly significant relationships.

Analysis of email and chat group usage is another means of trying to determine the user's personal relationships. Here too, one cannot be sure that the given user is actually close to a second user simply because they sent or received mail from them. For example, the user might constantly receive a flood of unwanted email (SPAM) from a particular source, a source to whom they are far from close. Further, since such usage analysis is done asynchronously, the relationships revealed are not necessarily current.

International publication number WO 01/050680 A3 describes a system and method that provides a single aggregated list of all of their personal contacts, source including personal desktop portal users, instant messaging users, e-mail addresses, and cell phones. No teachings are provided allowing others to inspect this aggregated list.

Services like Friendster (for details see http://www.friendster.com/info/moreinfo.jsp) provide online environments wherein given user can specify a particular set users to whom they are close. Since this involves an external service, the people that can be included in the given user's list are limited to other's who are also service participants. Even if all of those that were important to the given user were service participants, the users would have to constantly manually update the service's version of their relationship list to match that in their real life.

Thus, there remains a need for a system and method that allows a second user to retrieve and inspect a dynamically updated social relationship collection of a first user, where the data sources for this relationship collection are applications where inputs are made by the first user manually, but where the updates to the network-accessible version are made automatically.

### SUMMARY OF INVENTION

An object of the present invention is to provide a method for allowing the sharing of social relationships collections including the step of creating a social relationship collection object for a first user that provides access to at least one individual with whom they have a social relationship and allowing a second user to retrieve the social relationship collection object. As a result of allowing the second user to retrieve the social relationship collection object, the second user inspects a reference contained in the first user's social relationship collection object.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF DRAWINGS

FIG. 1 shows an example of the network topology according an embodiment of the present invention.

FIG. 2 shows an example of a component diagram of the server according an embodiment of the present invention.

FIG. 3 shows an example of the server's logic according an embodiment of the present invention.

FIG. 4 shows an example of a component diagram of the client according an embodiment of the present invention.

FIG. 5 shows an example of the client's logic according an embodiment of the present invention.

FIG. 6a shows an example of an augmented buddy list according an embodiment of the present invention.

FIG. 6b shows an example of a retrieved, augmented buddy list according an embodiment of the present invention.

FIG. 6c shows an example of a mediated, augmented buddy list according an embodiment of the present invention.

FIG. 7 shows an example of the overall method according an embodiment of the present invention.

### DETAILED DESCRIPTION

A detailed example of an embodiment of the current invention is given, describing how the current invention is used to allow a second user to retrieve and inspect the social relationship collection of a first user, this retrieval and inspection may be accomplished via a web browser communicating with a web-based (HTTP) social relationship collection server.

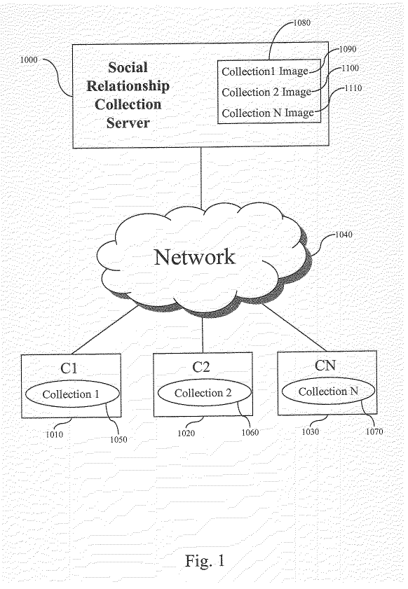

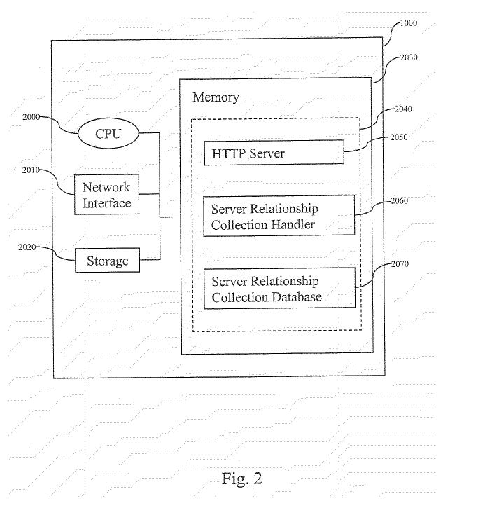

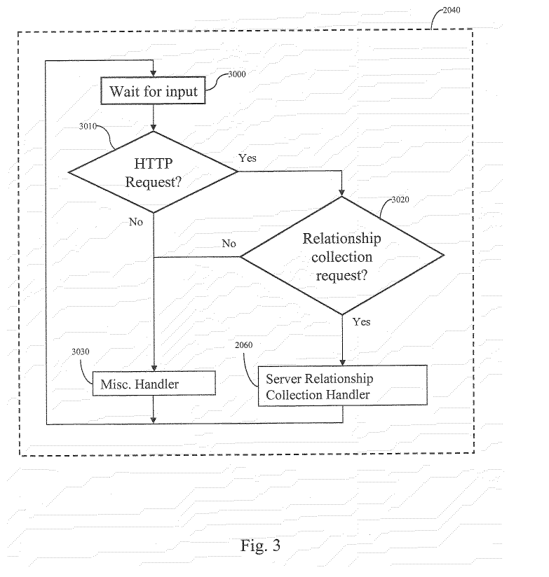

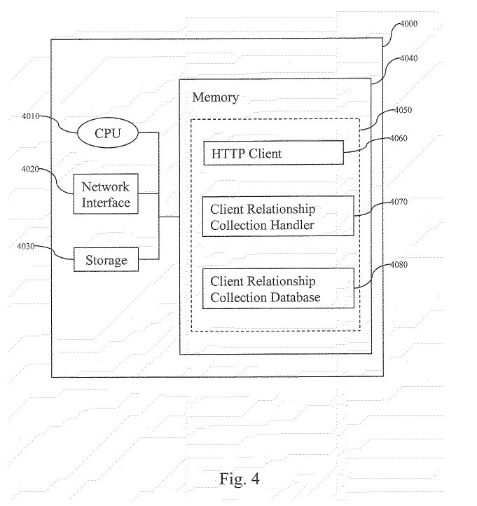

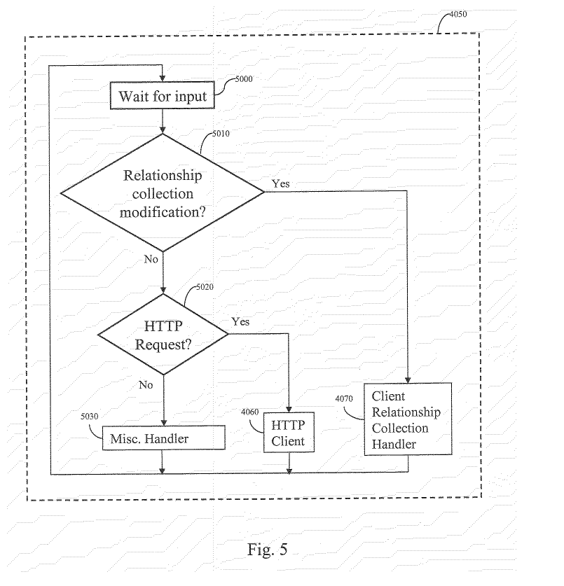

FIG. 1 depicts an example of a network topology of the preferred embodiment. As shown, there are three client nodes, C1, C2 and CN, 1010 through 1030, respectively (described in detail with reference to FIGS. 4 and 5), connected through network 1040 to server 1000 (described in detail with reference to FIGS. 2, and 3). The network 1040 includes, but is not limited to the Internet, or an internal intranet, or wireless or wired telecommunication network. Although only three client nodes 1010 1030 are pictured in FIG. 1, the current invention is applicable to any greater number as well. Also, note that although the preferred embodiment involves a TCP/IP-based network application, other forms of network communication are also applicable.

The social relationship collections of the associated users of C1, C2 and CN, 1010-1030 are also shown in FIG. 1 as Collection 1, Collection 2 and Collection N, 1050 1070, respectively. The network accessible image of each of these collections is shown as held within a data-store 1080 in the Social Relationship Collection Server 1000, these represented by Collection 1 Image 1090, Collection 2 Image 1100, and Collection N Image 1110, respectively. As will be described in detail with references to FIG. 2 5 and 7, the collection images 1090 1110 held on the sever 1000 are updated whenever necessary to match their real-life counterpart 1050 1070, respectively.

FIG. 2 depicts a more detailed component diagram of the server node 1000, which manages all users' social relationship collection images 1090 1110 and provides web-based access to them. This server 1000 can be any computing node able to act as an HTTP server. This includes, but is not limited to, the products sold by IBM under the trademarks ThinkPad or PowerPC, running the operating system and server application suite sold by Microsoft under the trademark Windows NT, or Linux.

The server 1000 preferably includes a CPU 2000, a network interface 2010, a storage device 2020 such as a disk or DASD, and memory 2030, such as RAM. According to the present invention, the server logic 2035 (which will be discussed in more detail with reference to FIG. 3), is preferably embodied as computer executable code that is loaded from remote source (e.g., over the network 1040 via the network interface 2010), local permanent optical (CD-ROM), magnetic storage (such as disk), or DASD 2020 into memory 2030 for execution by CPU 2000. The memory 2030 preferably includes: An HTTP Server Handler 2050 (discussed in detail with reference to FIG. 3), A Server Relationship Collection Handle 2060, and A Server Relationship Collection Database 2070.

The Server Relationship Collection Database 2070 can be any application providing access and persistent management of data, such as that sold by IBM under the trademark DB/2. Those with regular skill in the art will also appreciate that the Server Relationship Collection Database 2070 could be run on another remote network-connected node and accessed via the network 1040.

FIG. 3 shows a detailed flow diagram of the server logic 2040, i.e., the server's 1000 control flow. As shown, the server 1000 awaits input in step 3000, and then checks whether the input is an HTTP request in step 3010. If the input is such an HTTP request, then the input is checked in step 3020 to see if it is relationship collection-related. If it is, then Server Relationship Collection Handler 2060 is invoked, following which control continues at step 3000. If the input is not relationship collection-related, then HTTP Server Handler 2050 is invoked, following which control continues at step 3000. If the input is not an HTTP request, then a miscellaneous handler, beyond the scope of the current invention, is invoked in step 3030, following which control continues at step 3000.

The Server Relationship Collection Handler 2060 manages all requests to create, modify and retrieve the social relationship collection images 1090 1110 it holds in the Server Relationship Collection Database 2070. In the preferred embodiment, all communication between this handler 2060 and clients is accomplished using HTTP (i.e., web-based) requests. There are two legal requests: Collection image updates, and Collection image retrievals.

Update requests include both a collection image and the associated user's ID. The handler 2060 first checks if there is an entry for the given ID in the database 2070, creating one if not. The handler 2060 then writes the given collection image into this entry, overwriting previous versions, if necessary. If successful, the handler 2060 return an HTML document to the requesting client indicating success.

Retrieval requests contain only the ID of the target user. The handler 2060, first checks with the database to ensure that there is an entry for the specified user ID, returning an error-indicating HTML document to the requesting client if not. Once found, the handler 2060 gets the relevant collection image from the database 2070. Then, using the collection's data, the handler 2060, builds an HTML document through which the user of the requesting client can inspect the collection.

One will appreciate a collection image request could also include the user ID of the requestor. With this data, the handler 2060 would be able to enforce access rights restrictions (e.g., “Only Bob, Jane and Terese can access my collection.”).

One will also appreciate that collection images can contain access rights specifications, specifications either the database 2070, or the handler 2060 can check before returning collection image data to anyone.

FIG. 4 depicts a more detailed component diagram of the client network node 4000 used by clients, C1, C2 and CN 1010 1030. For any participating user, their client machine (i.e., one of 1010 1030) acts as both their relationship collection source (i.e., the source from which the collection images 1090 1110 are transmitted to the server 1000), and their window into other users' relationship collections (i.e., via the HTML collection-renderings retrieved from the server 1000 by their HTTP client 4060 using HTTP).

Examples of platforms that support the client 4000 include, but are not limited to, an IBM ThinkPad running Windows 95 and a web browser such as Microsoft's Internet Explorer. Clients can also include network-connectable mobile (i.e., portable) devices such as that sold under the trademark WorkPad by IBM, as well as smart cellular telephones (i.e., devices which can act as a cellular telephone as well as run network applications, like web browsers), like that sold under the trademark Nokia 90008 by Nokia.

As shown in FIG. 4, a client node 4000, preferably include: A CPU 4010, A network interface 4020, A storage device 4030 (e.g., a disk or DASD), and Memory 4040 (e.g., RAM).

According to the present invention, the client logic 4050 (which will be discussed in more detail with reference to FIG. 5), is preferably embodied as computer executable code that is loaded from a remote source (e.g., over the network 1040 via the network adapter 4020), local permanent optical (CD-ROM), magnetic storage (such as disk), or DASD 4030 into memory 4040 for execution by CPU 4010. The memory 4040 preferably includes: An HTTP Client 4060 (e.g., a web browser), and A Client Relationship Collection Handler 4070 (discussed in detail with reference to FIG. 5), and A Client Relationship Collection Database 4080,The HTTP Client, being any type of web browser, can include but is not limited to the product sold by Microsoft under the trademark Internet Explorer, or that sold by Opera Software for smart phone and personal data assistants (PDAs).

The Client Relationship Collection Database 4080 can be any application providing access and persistent management of data, such as that sold by IBM under the trademark DB/2. Those with regular skill in the art will also appreciate that the Client Relationship Collection Database 4080 could be run on another remote network-connected node and accessed via the network 1040.

FIG. 5 shows a detailed flow diagram of the clients' logic 4050. In the preferred implementation, the client's logic 4050, as depicted in FIG. 5, the client 4000 awaits input in step 5000. Once received, the input is checked to see whether it is a relationship collection modification in step 5010. Such modifications include any user initiated event that directly results in a change of one or more of the user's social relationship collections. Such events include, but are not limited to the user: Modifying their buddy list (e.g., Sametime or AOL Instant messenger), Modifying their personal address book (e.g., Lotus Note's address book), Creating or modifying the user list or access rights on one or more of their personal computing devices (e.g., creating a user account for a close coworker, giving them read, write, and execute rights to the user's home directory).

In each case, the Client Relationship Collection Handler 4070: Retrieves the necessary information from the given client 4000, Updates the given user's relationship collection (e.g., Collection 1 1050), stored in the Client Relationship Collection Database 4080, and then Updates the server 1000 image of the client's relationship collection (e.g., Collection 1 Image 1090) using an HTTP request, one containing both the user's ID and the new, updated relationship collection.

One will appreciate that in addition to actual relationship entries (e.g., references to particular individuals) a given user's relationship collection can contain instructions specifying the sources of the relationship data, as well as descriptions of how the data is to be retrieved. A given user, for example could specify that they want both the entries from their Sametime buddy list and from their personal Lotus Notes address book used as relationship data sources. Given this directive, any modification to either of the user's buddy list or address book would constitute a relationship modification and would have to be processed by the Client Relationship Collection Handler 4070.

One will also appreciate that a given user can also specify access rights in their relationship collection, rights that will enforced by the Server Relationship Collection Handler 2060. E.g., a user can specify that only requests with particular user IDs are allowed to retrieve their relationship collection. Similarly, a user can specify that particular user IDs are not allowed to retrieve their relationship collection.

One further will appreciate that a given user can segment their relationship collection, e.g., into work-related contacts and family-related contacts, and then provide separate access rights for each segment. E.g., only members of my department (specified via a set of user IDs) are allowed to retrieve my work-related social collection segment, while only family members are allowed to retrieve my family-related social collection segment.

After completion of the Client Relationship Collection Handler 4070 control resumes at step 5000.

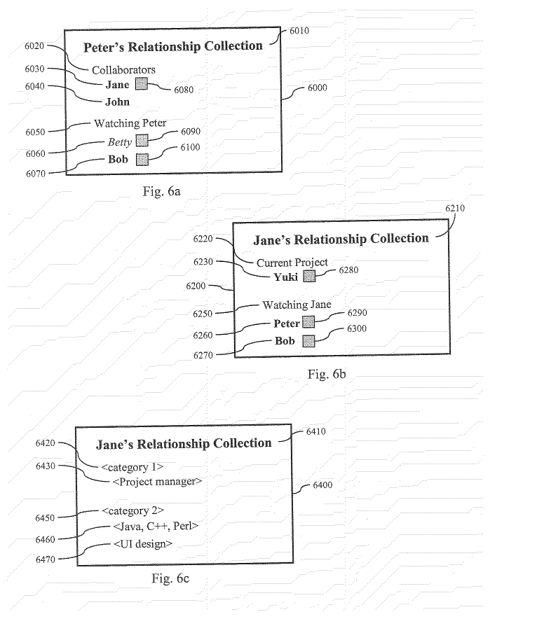

If the input is not a relationship collection modification, then step 5020 checks whether it is the user making an HTTP request. If so, the HTTP Client 4060 is invoked, following which control continues at step 5000. One such HTTP-based request could be a request from the server 1000 by one user for another user's relationship collection image (e.g., 1110). Examples of the web pages retrieved by the client 4000 will be discussed in detail with references to FIGS. 6a, 6b and 6c.

If the input is not an HTTP request, then a miscellaneous handler, beyond the scope of the current invention, is invoked in step 5030, following which control resumes at step 5000.

FIGS. 6a, 6b and 6c all depicts web pages (HTML documents) retrieved by a client's HTTP client 4060 from the server 1000. One with regular skill in the art will appreciate that other client server architectures are also applicable, including, but not limited to client and server applications using TCP sockets for communication (for details, see Douglas Comer, Internetworking with TCP/IP, Vol. 1 Principles, Protocols and Architecture. Prentice Hall, Englewood Cliffs, N.J., 1991).

FIG. 6a shows an example of a user's social relationship collection after it has been retrieved from the server 1000 and rendered by the client's HTTP Client 4060. As shown the web page 6000 includes a title 6010 indicating the ID of the associated user's ID, “Peter,” and two sections indicated by titles “Collaborators” 6020 and “Watching Peter” 6050. The first section 6020 contains two references “Jane” 6030 and “John.” 6040, as does the second section 6050: “Betty” 6060 and “Bob” 6070.

Three of the references 6030, 6040 and 6070 are in bold, while the fourth 6060 is in italics. Those with regular skill in the art and familiar with Sametime Buddy Lists will appreciate this is meant to indicate that while the users corresponding to 6030, 66040 and 6070 are currently active, the fourth user 6060, is not.

Unlike a standard Sametime buddy lists, three of the four references have social relationship collection icons 6080, 6090 and 6100 to their right. When one these icons is selected, the social relationship collection for the corresponding user is retrieved. Thus, if one selected 6080, the social relationship collection for Jane would be retrieved and displayed. This might be a useful way of getting a hold of a co-worker who you know is a close associate of one of your buddies, perhaps to serve as a surrogate for your buddy, or for other ends.

With reference to any privacy issues, users may have the option of making their relationship collection visible to all, to only those in their relationship collections, to only people in their workgroup, or to only those who have also made their relationship collections visible, etc.

Another alternative would be to allow people to designate whether a particular entry would be viewable by others. This could allow a person to designate others to go to for various sorts of help, e.g., “For help on Loops, contact Wendy” “For info about the Conference Call Proxy, contact Tracee”.

The FIG. 6a also adds a new (automatic) category 6050 that is denoted by the title “Watching Peter.” This category 6050 shows who currently has the user in their relationship collections. Thus, Betty and Bob both have Peter in their relationship collections. In theory, this seems fair; people being observed could certainly argue they have a right to know who is watching. On the other hand, it might undermine current usage by making a “watcher” accountable for who and why they are observing someone.

One might imagine various ways of extending this idea, by, for example, having a category of “those who have watched me in the last week,” and so on.

One way of lessening the impact of making watching explicit would be to provide a mechanism that allowed people to register their intent. Thus, we might imagine categories such as “It's useful to know when you're around,” or other categories such as “I'd like to have a short chat with you, at your convenience.” This is undoubtedly a cumbersome way of embodying this functionality, but despite that the idea of using IM to register interest in an interaction some time in the future (or even at a particular time in the future) could be worth exploring.

FIG. 6b shows the rendering 6200 of the social relationship collection retrieved when Jane's relationship collection icon 6080 is selected. As shown, the web page 6200 contains: A title 6210 indicating Jane as the owner of the collection; Two sections, “Current Project” 6220 and “Watching Jane” 6250, The first section 6220 containing a reference to “Yuki” 6230, The second section containing references to both “Peter” 6260 and “Bob” 6270; and The references to Yuki 6230, Peter 6260, and Bob 6270 having social relationship collection icons 6280, 6290 and 6300 associated with them, respectively.

Another response to the privacy concerns raised above is to replace the user IDs or those referenced with some sort of description: possible manually assigned by the collection owner, or automatically drawn from online sources, such as personal pages or organizational hierarchy charts. FIG. 6c shows one example or a modified version of FIG. 6b with section names anonymized and user names replaced by short descriptions of expertise or position. Thus, while the web page 6400 still has title 6410 indicating that the Jane is the owner of the collection, “Current Project” 6220 is now “<category 1>” 6420, “Yuki” 6230 is now “<Project manager>” 6430, “Watching Jane” is now <category 2“6450, “Peter” 6260 is now “<Java, C++, Perl>” 6460, and “Bob” 6270 is now “<UI design>” 6470, and all of the social relationship collection icons are gone. Here, to contact Bob, a given user e-mail Jane and say “I see a UI design expert in your buddy list . . . would you tell me who they are and perhaps introduce me?” Not shown, but nevertheless imaginable, might be some sort of ID # (or simply <entry N in category M>) which could be passed to Mathew to allow him to quickly identify to whom you are referring.

As alternative approach, instead of surfing your buddies' social relationship collections, one could instead define search criterion and select which of your buddies to search.

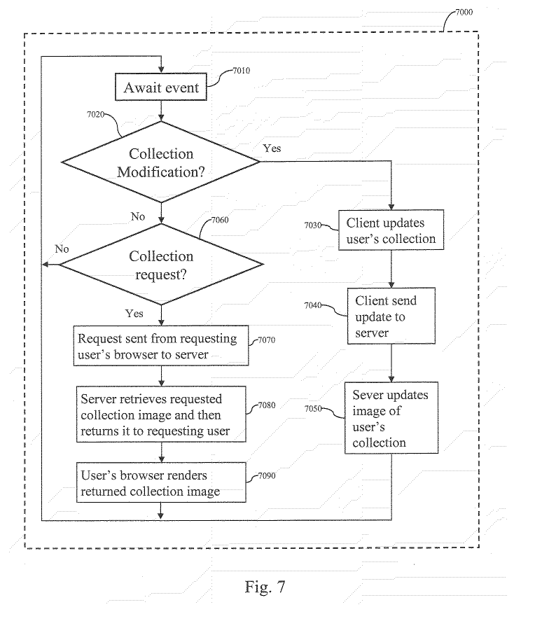

FIG. 7 shows a detailed flow diagram of the overall social relationship collection management process 7000. First, in step 7010, the process awaits a relevant event. When an event is received, it is check in step 7020 to see if it concerns the modification of some user's social relationship collection. If so, then in step 7030 Client Relationship Collection Handler 4070 of the associated user's client 4000 updates the users collection, storing the updated collection in the relevant client's 4000 Client Relationship Collection Database 4070. Next, in step 7040 the Client Relationship Collection Handler 4070 sends an update request to the server 1000. In step 7050, the server's 1000 Server Relationship Collection Handler 2060 updates the relevant collection image, storing it in the Server Relationship Collection Database 2070, following which control continues at step 7010.

If the event is not a collection modification, then it is checked in step 7060 to see if it is a collection request. If not, control continues at step 7010. If it is, then in step 7070 the requesting client's HTTP client 4060, send a request to the Server 1000. In step 7080, the server's 1000 Server Relationship Collection Handler 2060 retrieves the requested collection image and then returns in to the requesting client. Finally, in step 7090, the relevant client's 4000 HTTP Client 4060 renders the returned collection for the requesting user to inspect. Following this, control continues at step 7010.

The current invention also provides methods where a first organization could employ and support the social relationship collection surfing techniques just described to a second organization.

First, one with regular skill in the art will appreciate that a first organization could enable a member of a second organization to surf social relationship collections. This provision includes determining the number of users that would be using the service, configuring a server 1000, and then installing the server 1000. The second organization would also have to ensure that members of the second organization had the required clients 4000 to interact with the current invention, upgrading the existing hardware and software if necessary.

The first organization could also administer one or more aspects of the social relationship collection surfing infrastructure. This support could include ensuring that proper operation of the server 1000 and all operating clients 4000, even checking that both the server 1000 and the clients 4000 have sufficient resources for their Server Relationship Collection Database 2070 and the Server Relationship Collection Databases 4080, respectivelyA first organization could also train members of a second organization to use the social relationship collections surfing methods and system provided by the current invention. This training could include explanation of how to restrict access to ones social relationship collections, and how user can set up select the data sources that will be used to determine their relationship collection (e.g., Sametime buddy list and personal address book).

A first organization could also support a second organization's use of the user ID replacement technique described with reference to FIG. 6c. This support could include the first organization's determining what online personal information sources the second organizations has, and then configuring the server 1000 to use these sources whenever user ID replacement is selected by a given user.

It is to be understood that the provided illustrative examples are by no means exhaustive of the many possible uses for the invention.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the embodiments described above, but encompasses any and all embodiments within the scope of the following claims:

1. A method for allowing the sharing of social relationships collections comprising the steps of:
creating a social relationship collection object for a first user that provides access to at least one individual with whom they have a social relationship;
allowing a second user to retrieve said social relationship collection object; and
as a result of allowing said second user to retrieve said social relationship collection object, said second user inspects a reference contained in the first user's social relationship collection object.

2. The method of claim 1 further comprising the step of providing said social relationship collection object as a user list.

3. The method of claim 2 further comprising the step of associating said user list with a meta-tag.

4. The method of claim 3 further comprising the step of automatically modifying the meta-tag when retrieved by said second user.

5. The method of claim 1 further comprising the step of providing meta-tags for said social relationship collection object for indicating when a given reference within said object was used.

6. The method of claim 1 further comprising the step of providing meta-tags that indicate the type of relationship between the first user and at least one reference within said social relationship collection object.

7. The method of claim 1 further comprising the step of providing a meta-tag for at least one reference within said social relationship collection object.

8. The method of claim 1 further comprising the step of providing usage history for at least one reference within said social relationship collection object.

9. A method for hosting a service that allows for the sharing of social relationships collections comprising the steps of:
creating a social relationship collection object for a first user that provides access to at least one individual with whom they have a social relationship;
allowing a second user to retrieve said social relationship collection object; and
as a result of allowing said second user to retrieve said social relationship collection object, said second user inspects a reference contained in the first user's social relationship collection object.

10. The method of claim 9 further comprising the step of providing said social relationship collection object as a user list.

11. The method of claim 10 further comprising the step of associating said user list with a meta-tag.

12. The method of claim 11 further comprising the step of automatically modifying the meta-tag when retrieved by said second user.

13. The method of claim 9 further comprising the step of providing meta-tags for said social relationship collection object for indicating when a given reference within said object was used.

14. The method of claim 9 further comprising the step of providing meta-tags that indicate the type of relationship between the first user and at least one reference within said social relationship collection object.

15. The method of claim 9 further comprising the step of providing a meta-tag for at least one reference within said social relationship collection object.

16. The method of claim 9 further comprising the step of providing usage history for at least one reference within said social relationship collection object.

17. An apparatus for use in a computer services environment, said apparatus comprising:
at least one processor operative to create a social relationship collection object for a first user that provides access to at least one reference with whom they have a social relationship, allow a second user to retrieve said social relationship collection object, and as a result of allowing said second user to retrieve said social relationship collection object, said second user inspects a reference contained in the first user's social relationship collection object.

18. A method for allowing a first organization to enable a second organization to use social relationship collection objects of the first organization, the method comprising the steps of:
determining the number of users in the second organization that would be using the social relationship collection objects of the first organization,
configuring and installing a server at the first organization to handle requests from the users of the second organization, and
ensuring the all relevant members of the second organization have a client application for accessing the server.
